(19) United States
(12) Patent Application Publication
(10) Pub. No.: US 2020/0050256 A1
(43) Pub. Date: Feb. 13, 2020

(54) TECHNIQUES TO CAUSE CHANGES IN BOTH VIRTUAL ENVIRONMENT AND PHYSICAL ENVIRONMENT

(71) Applicant: Google LLC, Mountain View, CA (US)

(72) Inventors: Darwin Yamamoto, Brooklyn, NY (US); Ian MacGillivray, New York, NY (US); Jason Toff, Hoboken, NJ (US); Shawn Buessing, New York, NY (US)

(21) Appl. No.: 15/878,948

(22) Filed: Jan. 24, 2018

Related U.S. Application Data
(60) Provisional application No. 62/450,428, filed on Jan. 25, 2017.

(51) Int. Cl. G06F 3/01; G06T 19/00; G06F 3/0481

(52) U.S. Cl. CPC G06F 3/011; G06F 3/04815; G06F 3/04817; G06T 19/006

(57) ABSTRACT

According to an example implementation, a method includes receiving an indication of a selected mode, and causing, at the same time, both a change in a virtual environment and a change in a physical environment in response to the selected mode.

### RELATED APPLICATION

This application claims priority to, and the benefit of, U.S. Provisional Application No. 62/450,428, filed on Jan. 25, 2017, entitled “Techniques to Cause Changes in Both Virtual Environment and Physical Environment”, which is incorporated herein by reference in its entirety.

### FIELD

This relates, generally, to an augmented and/or virtual reality environment, and in particular, to various techniques that may be used to cause changes in both a virtual environment (or virtual world) and a physical environment (or physical world).

### BACKGROUND

An augmented reality (AR) and/or a virtual reality (VR) system may generate a three-dimensional (3D) immersive virtual environment. A user may experience this 3D immersive virtual environment through interaction with various electronic devices, such as, for example, a helmet or other head mounted device including a display, glasses or goggles that a user looks through when viewing a display device, gloves fitted with sensors, external handheld devices that include sensors, and other such electronic devices. Once immersed in the 3D virtual environment, the user may move through the virtual environment and move to other areas of the virtual environment, through physical movement and/or manipulation of an electronic device to interact with the virtual environment and personalize interaction with the virtual environment.

### SUMMARY

In one aspect, a method may include generating, by a virtual reality application, a virtual environment, determining that a button has been actuated, and causing a virtual change in the virtual environment and a physical change in a physical environment in response to the determining that the button has been actuated, the virtual change being a virtual representation of the physical change.

In another aspect, a system may include a computing device configured to generate an immersive virtual environment. The computing device may include a memory storing executable instructions, and a processor configured to execute the instructions. Execution of the instructions may cause the computing device to generate, by a virtual reality application, a virtual environment, determine that a button has been actuated, and causing a virtual change in the virtual environment and a physical change in a physical environment in response to the determining that the button has been actuated, the virtual change being a virtual representation of the physical change.

In another aspect, a method may include receiving an indication of a selected mode, providing, in both a virtual environment and a physical environment, a change of an environmental condition based on the selected mode, wherein a characteristic of the environmental condition of the virtual environment is same as a characteristic of the environmental condition of the physical environment.

In another aspect, a method may include receiving an indication of a selected mode in response to a physical button or switch that may be physically selected or actuated, providing a first environmental condition in a virtual environment, providing a second environmental condition in a physical environment, and causing a change in both the first environmental condition of the virtual environment and the second environmental condition of the physical environment such that the first environmental condition of the virtual environment corresponds to the second environmental condition of the physical environment.

In another aspect, a system may include a computing device configured to generate an immersive virtual environment. The computing device may include a memory storing executable instructions, and a processor configured to execute the instructions. Execution of the instructions may cause the computing device to receive an indication of a selected mode, and cause, at the same time, both a change in a virtual environment and a change in a physical environment in response to the selected mode.

The details of one or more implementations are set forth in the accompanying drawings and the description below. Other features will be apparent from the description and drawings, and from the claims.

### BRIEF DESCRIPTION OF THE DRAWINGS

FIG. 1 is a diagram illustrating a system according to an example implementation.

FIGS. 2A and 2B are diagrams illustrating virtual reality environments according to example implementations.

FIG. 3A is a flow chart illustrating operation of a system according to an example implementation.

FIG. 3B is a flow chart illustrating operation of a system according to another example implementation.

FIG. 4 is an example implementation of a virtual reality system including a head mounted display and a handheld electronic device, in accordance with implementations described herein.

FIGS. 5A and 5B are perspective views of an example head mounted display device, and FIG. 5C illustrates an example handheld electronic device, in accordance with implementations described herein.

FIG. 6 is a block diagram of a head mounted electronic device and a handheld electronic device, in accordance with embodiments as described herein.

FIG. 7 shows an example of a computer device and a mobile computer device that can be used to implement the techniques described herein.

### DETAILED DESCRIPTION

A user immersed in a 3D augmented and/or virtual reality environment wearing, for example, a head mounted display (HMD) device may explore the 3D virtual environment and interact with the 3D virtual environment through various different types of inputs. These inputs may include, for example, physical interaction including, for example, manipulation of an electronic device separate from the HMD such as, for example, via a ray or beam emitted by the electronic device and/or a virtual beam rendered in the virtual environment based on the manipulation of the electronic device, a movement of the electronic device, a touch applied on a touch sensitive surface of the electronic device and the like, and/or manipulation of the HMD itself, and/or hand/arm gestures, head movement and/or head and/or eye directional gaze and the like. A user may implement one or more of these different types of interactions to execute a particular action in the virtual environment, such as, for example, moving through the virtual environment, and moving, or transitioning, or teleporting, from a first area of the virtual environment to a second area of the virtual environment, or from a first virtual environment to a second virtual environment.

According to an illustrative example implementation, a user of a virtual reality (VR) system may receive audio/visual information via a VR system, such as via a head mounted display (HMD), as part of a 3D augmented and/or VR environment. In some cases, the audio and/or visual input provided by a VR system may provide a limited experience for the user. Rather, it may be desirable, in order to enhance the VR user experience, to also provide physical input(s) or physical stimuli to the user in the physical environment (PE), e.g., via one or more of the five senses of the user, such as sight, hearing, touch, smell, taste. According to an example implementation, in order to enhance the VR user experience, it may be desirable to provide the user with one or more changes in a physical environment (PE) or physical world (PW) which may be consistent with changes in a virtual environment (VE) or virtual world (VW), or may be coordinated with one or more changes performed in a virtual environment. Or alternatively, changes in the virtual environment may be coordinated based on physical changes that are performed or have occurred in the physical environment. Thus, for example, by performing changes in both a physical environment and a virtual environment, and/or by coordinating changes performed in the virtual environment and changes performed in the physical environment, an enhanced user experience may be provided.

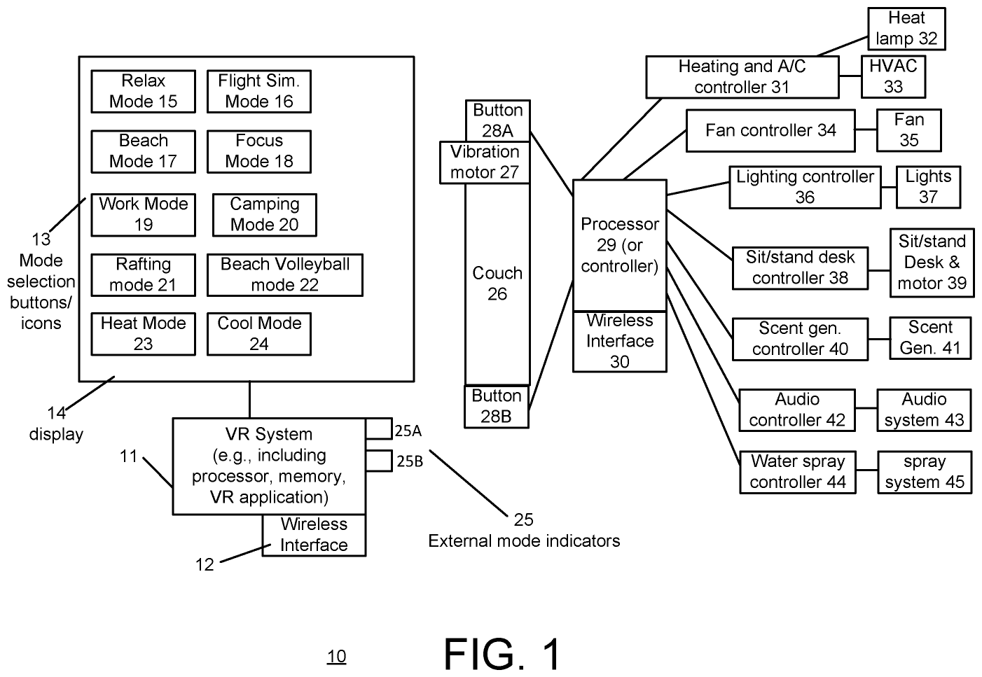

FIG. 1 is a diagram illustrating a system according to an example implementation. The system of FIG. 1 may allow changes to be performed in both a virtual environment and a physical environment. Also, the system of FIG. 1 may allow coordination of changes in both a physical environment and a virtual environment according to an example implementation.

Referring to FIG. 11, system 10 may include a virtual reality (VR) system 11, e.g., which may include a processor, memory, a VR application(s), a display, and/or other hardware and/or software for presenting an augmented and/or VR environment to a user. VR system 11 may also include a wireless interface 12 for wireless communication. A display 14, e.g., which may be provided as part of a VR system, may display one or more mode selection buttons or icons 13 that may be selected by a user to select a user mode or mode of operation for the VR system 12. The mode buttons or icons 13 may include one or more physical buttons that may be physically selected and/or one or more virtual (or soft) buttons or elements of a graphical user interface (GUI) that may be displayed on screen or display and then selected by a user via electronic device, such as via a touch-sensitive screen or display, a pointing device, etc.

Some example mode selection buttons (or icons) 13 are shown, such as, for example: a relax mode button 15 to cause VR system 11 to provide a relaxing VR environment; a flight simulator mode button 16 to cause a flight simulator VR game or experience to be provided to the user; a beach mode button 17 to cause VR system 11 to provide a beach VR environment to the user, e.g., including a 3D video of a beach, with ocean waves, sea gulls, etc., and/or sounds of the ocean; a focus mode button 18 that may cause VR system 11 to provide a user with a VR environment that may be useful in allowing a user to focus, e.g., a specific type of video and/or music; a work mode button 19 that may cause VR system 11 to provide a VR environment that may assist with a user in working, e.g., a specific audio and/or video for this purpose; a camping mode button 20 that may cause the VR system 11 to provide a camping VR environment, e.g., with a video of a camping scene with tents, a campfire, trees, crickets chirping, etc.; a rafting (e.g., white water rafting) mode button 21 to cause the VR system to provide a rafting VR environment (e.g., a whitewater rafting VR game), e.g., including video of rafting down a river, and showing other rafts ahead of the user's raft; a beach volleyball mode button 22 to cause the VR system 11 to allow the user to play a beach volleyball VR game or experience or view a beach volleyball game; a heat mode button 23 which a user may press (e.g., if the user is cold) to cause a heating (or a warm or at least warmer) VR environment to be provided by VR system 11 to the user, e.g. clouds part, and the sun comes out as part of the 3D video presented by VR system 11 to the user, e.g., to provide the impression of heating or a warming environment; and, a cool mode button 24 which a user may press or select (e.g., if the user is hot, and wants to cool down) to cause a cooling (or a cool/cooler) VR environment to be provided by VR system 11 to the user, e.g., clouds cover the sun, a snow or mountain scene with wind and snow blowing, is displayed by VR system 11 as part of the 3D video, to provide the impression of cooling or a cooler environment, for example. These are just some example modes and mode selection buttons 13 (or icons or GUI elements) that may be selected for the VR system 11, and other modes or mode selection buttons may be provided. In this manner, VR system 11 may perform changes in a virtual environment in response to the selection of one of a plurality of modes (e.g., user modes).

A processor (or controller) 29 may control one or more aspects of a physical environment (PE), such as, for example, a temperature, wind (or flow of air), lighting, a position or movement of a piece of furniture, a scent, a sound, music or other audio signals, spraying water or mist, etc. A wireless interface 30 may allow processor 29 (for controlling one or more aspects of a physical environment) to communicate with VR system 11 (for controlling one or more aspects of a virtual environment) via wireless interface 12. One or more items in a physical environment may be controlled, e.g., either in response to a user pushing or selecting a button within the physical world, or based on or in response to processor 29 receiving a control signal from VR system 11 (e.g., via wireless interfaces 12 and 30).

According to an example implementation, in response to a mode selection or a button being selected or pressed, changes may be performed in both the physical environment and the virtual environment. For example, by performing changes in both the physical environment and a virtual environment in response to a mode selection or a button being pressed or selected, this may allow the changes in the virtual environment and physical environment to be coordinated in time and may be consistent or both changes may provide a user experience that is consistent with the selected mode both in the virtual environment and the physical environment. Hence, characteristics of environmental conditions in the virtual environment and the physical environment are the same. For example, the characteristic of the environmental condition may relate to weather-related conditions (e.g., temperature, air pressure, lighting, water, scent, sound, etc.), positional-related conditions (e.g., position level of a user, position level of a piece of furniture, etc.), and/or movement-related conditions (e.g., movement of a user, movement of a piece of furniture, etc.). Either the VR system 11 (e.g., which controls the virtual environment) or processor 29 (e.g., which controls one or more aspects of a physical environment) may receive or detect a mode selection and initiate changes in both the physical and virtual environments.

According to an example implementation, in response to a mode selection or a button being selected or actuated, the system may perform a virtual change in a virtual environment and a physical change in a physical environment. The virtual change may be a virtual representation of the physical change. For example, the virtual representation of the virtual change may be e.g., displaying a video, outputting audio information, in which the virtual change may correspond to the physical change of the physical environment. Alternatively, the system may also cause the physical change to be a physical implementation of the virtual change. For example, the physical implementation of physical change may be, e.g., relating to temperature, wind (or flow of air), lighting, position or movement of a piece of furniture, scent, sound, music or other audio signals, spraying water or mist, etc., in which the physical change may correspond to the virtual change of the virtual environment. Hence, the system of FIG. 1 may support the virtual change or the physical change to be performed in the virtual environment or the physical environment in either direction (e.g., changes to be performed in both a virtual environment and/or a physical environment).

According to a first illustrative example implementation, VR system 11 may detect that one of the mode selection buttons 13 have been pressed or selected (to select a specific user mode). In response to detecting the selection of a mode selection button 13 (or in response to receiving a selection of a mode), the VR system 11 may perform one or more changes in the virtual environment based on the selected mode, e.g., by displaying a 3D video and/or outputting audio information to provide a VR environment to the user based on or in accordance with the selected mode. At the same time, or shortly after receiving the mode selection or after detecting the selection or pressing of a mode selection button 13, VR system 11 may also send a control signal (e.g., a mode indication signal, sent via wireless interface 12 and wireless interface 30) to the processor 29 (or other processor or controller) to indicate the selected mode to cause processor 29 to perform a change within the physical environment based on or in accordance with the selected mode.

According to a second illustrative example implementation, a button or icon may be selected in a physical environment may be pressed or selected by a user. For example, a button, icon or selectable item may be selected, e.g., such as a button (e.g., physical button or a virtual or soft button) on for controlling a couch, or a button for controlling a position for a sit-stand desk, or a button, or selectable item that is in communication with processor 29, as illustrative examples. For example, a computer may include processor 29, memory, an application for managing various items within the physical environment, and one or more buttons (physical buttons or soft/virtual buttons) to allow a user to select a mode or cause a change within the physical environment. For example, a display may be provided, which is connected to processor 29, to allow a user to select, input a mode, or control operation (e.g., by selecting or indicating a mode, such as by indicating a requested operation to be performed or a change to be made in physical environment) of one or more items within the physical environment (e.g., to control operation or perform a change in one or more of a heating and air conditioning, a fan, lights, position or movement of furniture, a scent generator, an audio system, a water spray system or other item). A processor (such as processor 29) may receive an indication of the selected or pressed button or icon on the PE (or an indication of a selected mode, such as a requested operation to be performed), and in response to the received input, processor 29 may cause changes to be performed in both the physical environment (e.g., adjusting a position or causing movement of a piece of furniture) and may also send a control signal (e.g., a mode indication signal, sent via wireless interface 12 and wireless interface 30) to the VR system 11 to indicate the selected mode (e.g., which may include an indication of a item or equipment, an indication of a selected operation to be performed on the item or equipment in the physical environment) to cause VR system to perform a change within the virtual environment based on or in accordance with the selected mode (based on the received signal). Several illustrative example implementations will be briefly described.

As shown in FIG. 1, a number of different items or equipment may be used to provide a controllable physical environment for a user. According to an example implementation, a couch 26 (or other piece of furniture) may be provided in which a user may sit. A vibration motor 27, when turned on, may cause couch 26 to vibrate. Vibration motor 27 may be activated or turned on and off based on a control signal from processor 29 and/or based on actuation or selection (e.g., pressing) of a button 28A (which may be a physical button or a soft or virtual button to allow a user to turn on and off the vibration of couch 26). A heating and air conditioning (A/C) controller 31 may control the operation of (e.g., turn on and/or off) a heat lamp 32 and/or a HVAC (heating, ventilation and air conditioning) system 33, e.g., to heat or cool a room. A fan controller 24 may control (e.g., turn on or off) a fan 35. A lighting controller 36 may control (e.g., turn on or off) one or more lights 37. A sit-stand desk controller 38 may control (and/or sense) a state or position of a sit-stand desk 39. A scent generator controller 40 may control the operation of scent generator 41, e.g., to cause generation and/or output of one or more scents, e.g., scent of pine trees, ocean salt water, suntan lotion, or other scent. An audio controller 42 may control the operation of audio system 43 (e.g., which may include an audio receiver, DVD player, speakers, etc.) to output or play a specific sound, music, or other audio output. A water spray controller 44 may control the operation of a spray system 45 to spray water or mist. These are merely a few illustrative example controllers and equipment that may provide a variable or controllable physical environment for a user.

According to an example implementation, a user may be sitting at a sit-stand desk 39. Then, the user may, for example, stand and then press or select a button on (or associated with) to cause the position of sit-stand desk to move from a sitting position to a standing position, or the user may manually adjust the position of sit-stand desk 39 to a standing position and the new position of sit-stand desk may be sensed or detected by controller 38 and/or processor 29. Controller 38 and/or processor 29 may then send a signal (e.g., via wireless interfaces 30 and 12) to VR system 11 to indicate the updated or new position (e.g., standing or raised position) of sit-stand desk (e.g., where the signal may also provide or indicate a new standing position of the user). In response to receive the signal indicating the new position of the desk (and/or indicating a new position of the user), VR system 11 may then adjust the perspective of the user in a VR game or VR experience or virtual environment that is displayed to the user, to reflect a raised or standing position of the user and that the desk 39 is raised. Thus, for example, VR system 11 may adjust view or perspective of a 3D video or images of a 3D video or images in a virtual environment to reflect a higher perspective of the user, e.g., to reflect or indicate that the user is now standing, and that objects on the floor around the user within a room are now further away relative to the user. In this manner, one control signal or control input (e.g., a button pressed to raise the position of the desk 39) received at a processor or controller at or associated with a physical environment, may cause changes to be performed in both the physical environment (e.g., causing a motor of desk 39 to raise the desk to standing position or raised position) and the virtual environment (e.g., a signal indicating a new or updated position of sit-stand desk to a raised position is sent to VR system 11 to cause VR system to adjust view or perspective of images or video presented to user in the virtual environment to reflect the user is now standing at his desk, rather than sitting at his desk).

In some implementations, one or more specific actions in the virtual environment may be configured at processor 29 to be performed in response to a user's experience during the VR game or VR experience or virtual environment. For example, using the above illustrative example, the user stands (or elevates above the ground during a VR game) in the virtual environment, VR system 11 may send a signal to the processor 29 to indicate the updated or new position of the user and cause a change to be performed in the physical environment (e.g., moving or adjusting (higher) a position of the sit-stand desk 39).

Thus, in this illustrative example, the change performed in the virtual environment and physical environment may be consistent with each other and/or may both support a user mode (e.g., provide input to the user that contributes to or reinforces the user mode or mode of operation that was selected), regardless of where a selection of the selection has been received or selected by a user, e.g., at the VR system 11, at a processor 29 controlling aspect(s) of the physical environment, or at a processor or system that may be used to control both changes in virtual environment and physical environment.

In some implementations, the change performed in the virtual environment and/or physical environment may be provided with respect to different senses of the user. For example, when a user presses or selects a button or item associated with raising the desk to a standing position, both: 1) a change in the physical environment, e.g., raising the desk 39 to a standing position, provided with respect to the user's sense of touch and 2) a change in the virtual environment, e.g., adjusting a perspective or view of the user within a 3D image or video that is displayed to the user within a VR system 11 or HMD to reflect the standing position of the desk and user, provided with respect to the user's sense of sight, are consistent with the standing mode (or standing state), and/or contribute to the mode (or state) of standing, as presented to the user, but for different user senses (sense and sight).

According to another example implementation, a user may be sitting on couch 26, and the user may press a button 28B that may indicate a request to enter a relax mode or relax state for the user. In response to the button 28B being pressed or in response to a signal indicating a relax mode, processor 29 may cause changes to be performed in both the physical environment and virtual environment. For example, in response to a relax mode signal, processor 29 may send a signal to lighting controller to dim lights 37, and may send a signal to audio controller 42 to cause audio system 43 to play a specific relaxing music for the user. Also, in response to receiving the relax mode signal, processor 29 may send a signal (e.g., a relax mode indication signal) indicating a user mode (relax mode in this example) to VR system 11. VR system 11 may then present or display a relaxing 3D video to the user, e.g., within an HMD, such as a relaxing beach scene, mountains, clouds or other relaxing scene that may be pre-selected by the user, or mapped or associated with the relax mode or relax state, for example. Similarly, one or more specific actions in the physical environment may also be configured at processor 29 to be performed in response to receiving a selection of a specific mode (either from a locally selected mode within the physical environment, or a mode indication signal received from VR system 11).

According to another example implementation, a user may select the button 15 for relax mode. VR system 11 may detect the selection of the relax mode (or relax state), and may cause changes (consistent with or that contribute to the selected mode) to be performed in both the virtual environment and physical environment in response to the selection of relax mode 15. For example, in response to the selection of relax mode, VR system 11 may present or display a relaxing virtual environment, e.g., by playing a 3D video of a relaxing beach scene with ocean waves rolling in. VR system 11 may also send a mode indication signal to processor 29 indicating that relax mode has been selected at the VR system 11. Processor 29, in response to receiving the relax mode indication signal from VR system 11, may perform one or more changes in physical environment that are consistent with or contribute to the selected relax mode (relax state). For example, processor 29 may send a signal to lighting controller to dim lights 37, and may send a signal to audio controller 42 to cause audio system 43 to play a specific relaxing music for the user. Therefore, in response to a mode selection at VR system 11, the VR system 11 may perform changes in a virtual environment (e.g., play a video of a relaxing scene on an HMD), and cause changes to be performed in a physical environment (e.g., to dim lights, and play relaxing music).

Thus, according to an example implementation, relax mode changes may be performed in both the virtual environment and the physical environment, regardless where a selection of the relax mode (or relax state) has been received or selected by a user, e.g., at the VR system 11, at a processor controlling aspect(s) of the physical environment, or at a processor or system that may be used to control both changes in virtual environment and physical environment. For example, one processor, e.g., the processor on VR system 11, or processor 29, may receive a mode selection (or mode state) from a user, and may then control changes (modifications) to a virtual environment (e.g., audio/video information presented to a user within a VR system or HMD) and a physical environment. In this last example, with only one processor or system to control both virtual and physical environments, it may be unnecessary to transmit a mode indication signal to another processor, although one or more physical systems may include their own controller, e.g., lighting controller, desk controller, audio controller, etc.

According to another example implementation, a user may select a flight simulator mode button 16. In response to detecting the selection of a flight simulator mode, VR system 11 may present a virtual experience of a flight simulator, e.g., by presenting or displaying a 3D flight simulator game to the user via a HMD. Also, in response to the selection of flight simulator mode, VR system 11 may send a flight simulator mode indication signal (e.g., indicating that a flight simulator mode has been selected at VR system 11) to processor 29 (or other controller or processor). Processor 29 may perform one or more changes in a physical environment that are consistent with or contribute to the selected flight simulator mode. For example, processor 29 may send a signal to turn on the vibration motor 27 to cause couch 26 to vibrate, thereby simulating the vibration caused by an airplane engine, for example. Alternatively, VR system 11 may send a signal directly to vibration motor 27 to turn on vibration motor 27, e.g., in the case that vibration motor may include a wireless interface for receiving signals from VR system 11. Thus, in this manner, in response to a selected flight simulator mode, VR system 11 may cause changes in both the virtual environment (e.g., playing a 3D video of a flight simulator, relating to a user's sense or sight) and the physical environment (e.g., by causing or sending a signal to processor 29 to cause the couch 26 to vibrate, relating to the user's sense of touch) that support or are consistent with the selected mode.

According to another example implementation, a user may select beach mode button 17 to select a beach mode or beach state. In response to the selected beach mode, VR system 11 may cause changes to be performed in both the virtual environment and physical environment that are consistent with and/or contribute to the selected beach mode. For example, for changes or modifications to the virtual environment, VR system 11 may display a 3D beach video to the user via HMD, e.g., including a beach, sun is shining, flags moving to indicate ocean breeze, ocean waves rolling into beach, sea gulls flying, etc., in response to detecting the selection of the beach mode. Also, VR system 11 may send a mode indication signal to processor 29 (or may directly communicate with one or more controllers for various physical systems) indicating the selected beach mode or beach state. In response to the beach mode indication signal, processor 29 may, for example, control controller 31 to turn on heat lamp 32 (e.g., to simulate warmth from shining sun), send a signal to fan controller 34 to turn on fan (e.g., to simulate the ocean breeze), send a signal to controller 40 to control scent generator 40 to generate or emit beach scents, such as salty ocean water scent, suntan lotion scent), and send a signal to controller 44 to cause spray system to spray water mist on the user to simulate spray from ocean waves, e.g., where spraying mist is timed or coordinated with the splashing of waves in 3D beach video played on HMD. For example, a specific timing of water spraying mist may be indicated by VR system 11 to processor 29 and/or controller 44, or a signal may be sent from VR system 11 to processor 29 and/or controller 44 each time a short water spray should be provided, e.g., timed with the receipt or crashing of a wave near the user on the beach within the 3D beach video presented to the user in a HMD as part of a virtual environment. Thus, a timing or coordination of a change to be performed (for virtual or physical environments) may be provided or sent by a VR system 11 to processor 29, or may be sent by a processor 29 to VR system 11, to allow a coordination or timed output of changes in both a virtual environment and physical environment so as to support or provide and improved user experience based on or in accordance with the selected mode.

Also, a change in a physical environment may mimic a change in a virtual environment, or a change in a physical environment may mimic a change in a virtual environment with respect to one or more characteristics. By mimic, this may include changes related to different senses to support a same characteristic of the selected mode. For example, for a characteristic of shining sun, turning on a heat lamp in a physical environment (related to sense of touch) may mimic (or be consistent with or support) the sun shining (related to sense of sight) in a 3D video within a virtual environment to support the beach mode. Or, for a characteristic of a running plane engine in the flight simulator mode, a vibration of couch 26 may mimic (or may be consistent with or may support) the running of the engine of the plane for the flight simulator.

According to an example implementation, a user may select a focus mode 18, or a work mode 19, to cause changes to be performed in the virtual environment and physical environment related to (or consistent with) each selected mode. In response to the selected focus mode (or work mode), VR system 11 may present a virtual experience of a work office setting (e.g., no noise or low background music, bright lights, proper chair and desk positioning, etc.). The focus mode may have a specific 3D video that may be played, a lighting setting that is set by lighting controller, a specific sound or music that is played by audio controller, a specific position of a coach or sit-stand desk that may be set, etc.

According to an example implementation, a user may select a camping mode button 20. In response to receiving the camping mode (or camping state) selection, VR system 11 may output or display a 3D video on an HMD that includes camping scenery, e.g., trees, a campsite, a camp fire, tents or cabins, someone playing a guitar around the campfire, etc. Also, VR system 11 may cause scent generator 41 to output one or more camping scents, such as campfire scent, a bug spray scent, and a pine tree scent, for example. Also, VR system 11 may cause audio system 43 to play or output audio sounds associated with camping or woods, such as a crackling campfire sound, crickets chirping, a guitar song that may be timed or coordinated with the 3D video of the person playing the guitar, where various control signals may be sent by VR system 11 to processor 29 to coordinate a start, stop or timing of the guitar sounds output by audio system 43 to coincide with when the person is (e.g., begins and ends) playing the guitar in the 3D video on the HMD, for example. For example, a “start song signal” may be sent from VR system 11 to processor 29 to cause the audio system 43 to begin playing the guitar song when or just before the person is shown on HMD as beginning to play the guitar around the campfire. Thus, for example, a timing of changes to be performed in the physical environment and virtual environment, related to different senses of the user, may be timed or coordinated by the sending of control signals between VR system (on the virtual environment side) 11 and a processor 29 or a controller (on the physical environment side).

According to an example implementation, a user may select a rafting mode button 21. In response to receiving the rafting mode selection, VR system 11 may output or display a 3D video on an HMD that includes a (whitewater) rafting scenery, e.g., rafts, rivers, rocks, mountains, tress, etc. Also, in response to the selection of rafting mode, VR system 11 may send a rafting mode indication signal to processor 29 (or other controller or processor). Processor 29 may perform one or more changes in a physical environment that are consistent with or contribute to the selected rafting mode. For example, processor 29 may send a signal to turn on the vibration motor 27 to cause couch 26 to vibrate (or rock back-and-forth), thereby simulating the rocking motion caused by the rapids, for example. VR system 11 may cause audio system 43 to generate a sound simulating the river and water crashing against the raft and/or rocks. Also, VR system 11 may cause spray system 45 to output water or mist to simulate water splashing into the raft. In some implementations, the spraying mist may be timed or coordinated with the splashing of waves in 3D whitewater raft played on HMD. For example, a specific timing of water spraying mist may be indicated by VR system 11 to processor 29 and/or controller 44, or a signal may be sent from VR system 11 to processor 29 and/or controller 44 each time a short water spray should be provided, e.g., timed with the receipt or crashing of a wave near the user in the raft. Thus, a timing or coordination of a change to be performed (for virtual or physical environments) may be provided or sent by a VR system 11 to processor 29, or may be sent by a processor 29 to VR system 11, to allow a coordination or timed output of changes in both a virtual environment and physical environment so as to support or provide and improved user experience based on or in accordance with the selected mode.

According to an example implementation, a user may select a beach mode volleyball mode 22. Physical environment changes and virtual environment changes may be performed for the selected beach volleyball mode. For example, in response to the beach volleyball mode selection, a 3D beach volleyball video may be presented or displayed to the user, along with heating controller 31 controlling the heat lamp 32 to raise the temperature of the room, audio controller 42 playing an audio sound of the ocean waves, and/or scent generator 41 expelling a substance to simulate a smell of suntan lotion.

According to another example implementation, a user may select a heat mode button 23, e.g., in the event the user is cold. In response to the heat mode, VR system 11 may display a video of the clouds parting, and the sun coming out, and VR system 11 may cause or control controller 31 to turn on heat lamp 32 (e.g., to simulate warmth of the sun), and control controller 31 to turn on the heat. Similarly, in response to a cool mode button 24 (e.g., which may be pressed or selected by a user when the user is hot), VR system 11 may display a 3D video of mountains with snow, the wind blowing, a frozen lake, or other video or images of a cold environment, while controlling fan 35 to turn on, and the air conditioning to turn on, and spray system 45 to spray mist to cool the user.

In some implementations, a user may select two or more mode selection buttons/icons 13 that are consistent in the selected environments including both the virtual environment and the physical environment. For example, if the user selects a camping mode button 20 and wants to experience camping at night, the user may then select a cool mode button 24 to cause changes (consistent with or that contribute to the selected mode) to be performed in both the virtual environment and physical environment in response to the selected camping and cool modes. In response to camping mode and cool mode selections, a nighttime camping video may be presented or displayed to the user, along with A/C controller 31 controlling the HVAC 33 to lower the temperature of the room, audio controller 42 playing audio sounds of a camp fire crackling, bugs chirping, animal noise, etc., and/or scent generator 41 expelling a substance to simulate smell of fire, pine trees, etc. Similarly, if the user selects a camping mode button 20 and wants to experience camping during the day, the user may then select a heat mode button 23 to cause changes (consistent with or that contribute to the selected mode) to be performed in both the virtual environment and physical environment in response to the selected camping and heat modes. In response to camping mode and heat mode selections, a daytime camping video may be presented or displayed to the user, along with heating controller 31 controlling the heat lamp 32 to raise the temperature of the room, audio controller 42 playing audio sounds of bugs chirping, animals noise, etc., and/or scent generator 41 expelling a substance to simulate smell of pine trees, suntan lotion, etc.

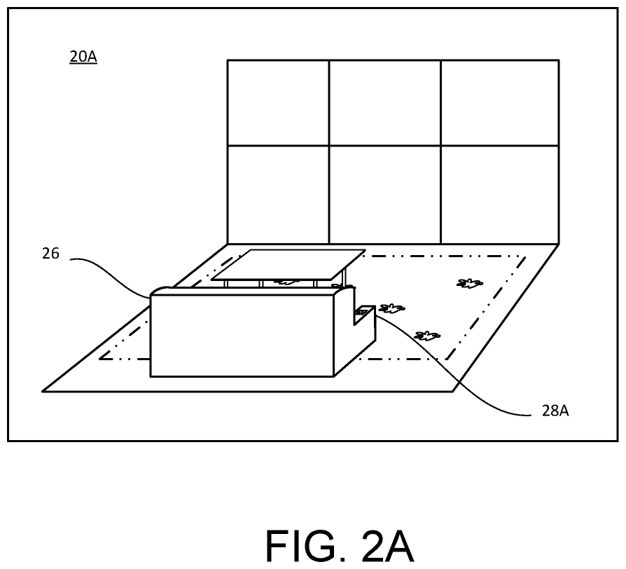

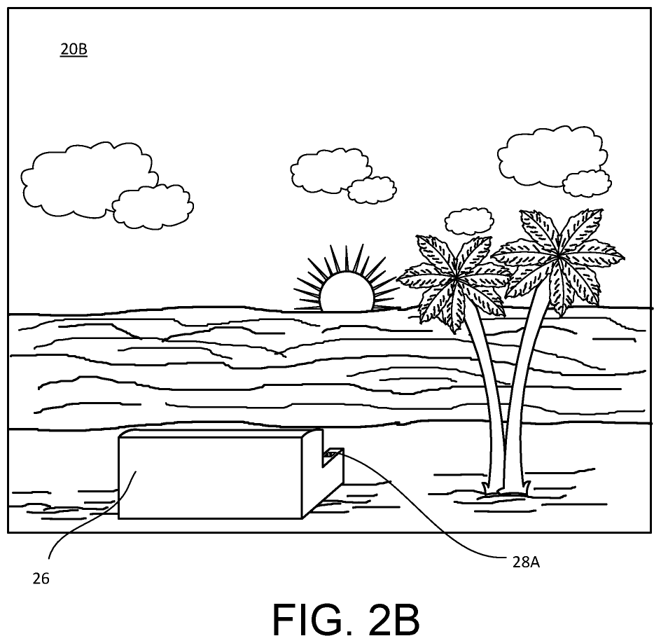

As shown in FIGS. 2A and 2B, a user may switch from one virtual environment to another virtual environment (e.g., between virtual worlds). In this illustrative implementation, the user switched from an office environment 20A (FIG. 2A) to a beach environment 20B (FIG. 2B) for relaxation. For example, the user may be sitting on couch 26 in the office virtual environment, and the user may press a button 28A that may indicate a request to enter a beach mode environment. In response to the selected beach mode, VR system 11 may detect the selection of the beach mode (or relax state), and may cause changes (consistent with or that contribute to the selected mode) to be performed in both the virtual environment and physical environment in response to the selection of beach mode. For example, in response to the selection of beach mode, VR system 11 may present or display a beach virtual environment, e.g., beach, sun, ocean breeze, ocean waves rolling into beach, sea gulls flying, etc. VR system 11 may also send a mode indication signal to processor 29 indicating that beach mode has been selected at the VR system 11. Processor 29, in response to receiving the beach mode indication signal from VR system 11, may perform one or more changes in physical environment that are consistent with or contribute to the selected beach mode. For example, processor 29 may send a signal to heating and A/C controller 31 to raise the temperature of the room, fan controller 34 to turn on the fan 35 to simulate a breeze, lighting controller 36 to enhance the lights 37, scent controller 40 to cause the scent generator 41 to expel substances associated with the beach (e.g., salt ocean, suntan lotion, fish, etc.), audio controller 42 to cause audio system 43 to play sounds associated with the beach (e.g., ocean waves, sea gulls, etc.), and/or water spray controller 44 to cause the spray system 45 to spray water or mist to simulate the ocean waves splashing on the beach. Therefore, in response to change in virtual environments (e.g., office mode to beach mode), the processor 29 causes changes to be performed in a physical environment.

VR system 11 may also include external mode indicators 25, such as mode (or state) indicators 25A, 25B, . . . , e.g., which may be lights, light emitting diodes, or other visual indicators, that may, e.g., indicate (e.g., to persons not using the VR system 12) the mode or state that the VR system 11 is in. For example, a different external mode indicator may be lit or activated to indicate a different VR mode, or a different color may be used to indicate different modes, or a text message, e.g., letter or abbreviation, may be activated to indicate a current mode or a selected mode of the VR system. For example, a different LED or other visual indicator may be provided on VR system to indicate different modes or states of the VR system, such as a relax mode, a work mode, a flight simulator mode, etc.

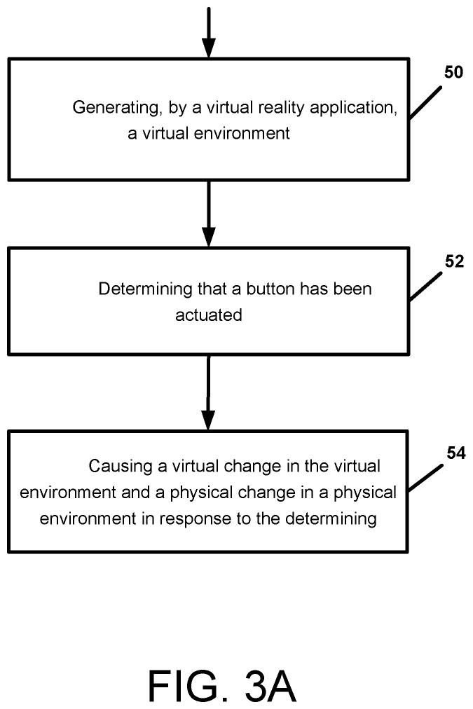

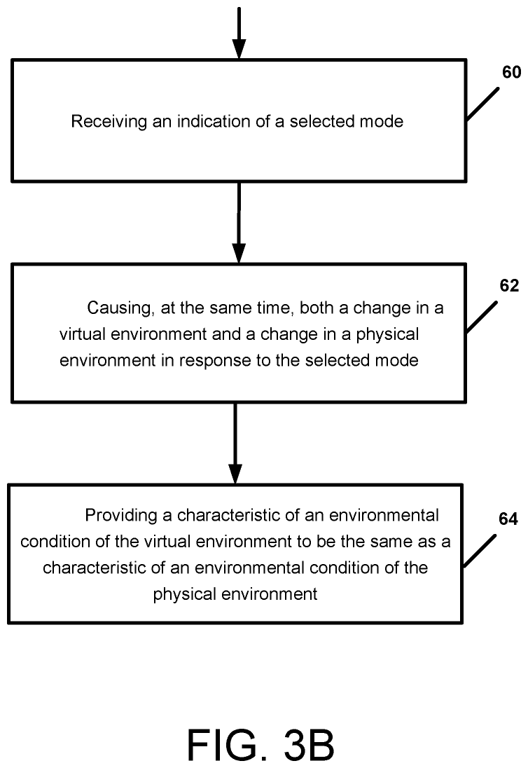

According to an example implementation, VR system 11 may include any type of computing system, such as a computer, laptop, mobile device, smart phone, tablet, and may include a HMD, and may typically include a processor, memory, a display or display device, and software or programs (or applications). In one illustrative example, VR system 11 may include a first electronic device 300 in communication with a second electronic device 302 (see FIG. 3). Also, or in the alternative, VR system 11 may include HMD 100 and/or a portable handheld electronic device 102. According to an example implementation, the VR system 11 may include a virtual reality application for generating and providing (e.g., displaying) an immersive 3D augmented and/or virtual reality (VR) environment or VR world or VR environment.

FIG. 3A is a flow chart illustrating operation of a computing system according to an example implementation. Operation 50 includes generating, by a virtual reality application, a virtual environment. Operation 52 includes determining that a button has been actuated. And, operation 54 includes causing a change in both the virtual environment and a physical environment in response to the determining.

FIG. 3B is a flow chart illustrating operation of a computing system according to another example implementation. Operation 60 includes receiving an indication of a selected mode. Operation 62 includes causing, at the same time, both a change in a virtual environment and a change in a physical environment in response to the selected mode. Operation 64 includes providing a characteristic of an environmental condition of the virtual environment to be the same as a characteristic of an environmental condition of the physical environment.

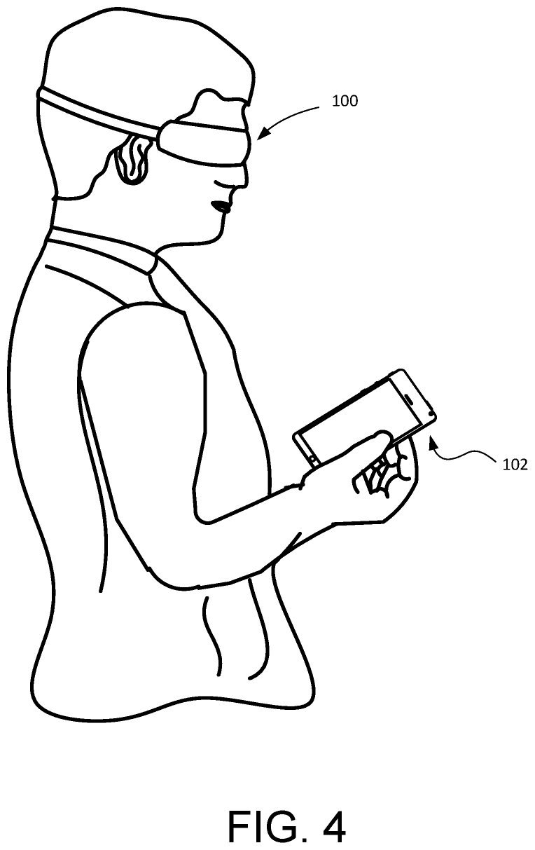

In the example implementation shown in FIG. 4, a user wearing an HMD 100 is holding a portable handheld electronic device 102. The handheld electronic device 102 may be, for example, a smartphone, a controller, a gyromouse, a joystick, or another portable handheld electronic device(s) that may be paired with, and communicate with, the HMD 100 for interaction in the immersive virtual environment generated by the HMD 100. The handheld electronic device 102 may be operably coupled with, or paired with the HMD 100 via, for example, a wired connection, or a wireless connection such as, for example, a WiFi or Bluetooth connection. This pairing, or operable coupling, of the handheld electronic device 102 and the HMD 100 may provide for communication and exchange of data between the handheld electronic device 102 and the HMD 100, and may allow the handheld electronic device 102 to function as a controller for interacting in the immersive virtual environment generated by the HMD 100. That is, a manipulation of the handheld electronic device 102, such as, for example, to generate a virtual beam or ray emitted by the handheld electronic device 102 directed to a virtual object or feature for selection, and/or an input received on a touch surface of the handheld electronic device 102, and/or a movement of the handheld electronic device 102, may be translated into a corresponding selection, or movement, or other type of interaction, in the immersive virtual environment generated by the HMD 100. For example, the HMD 100, together with the handheld electronic device 102, may generate a virtual environment as described above, and the handheld electronic device 102 may be manipulated to effect a change in scale, or perspective, of the user relative to the virtual features in the virtual environment as described above.

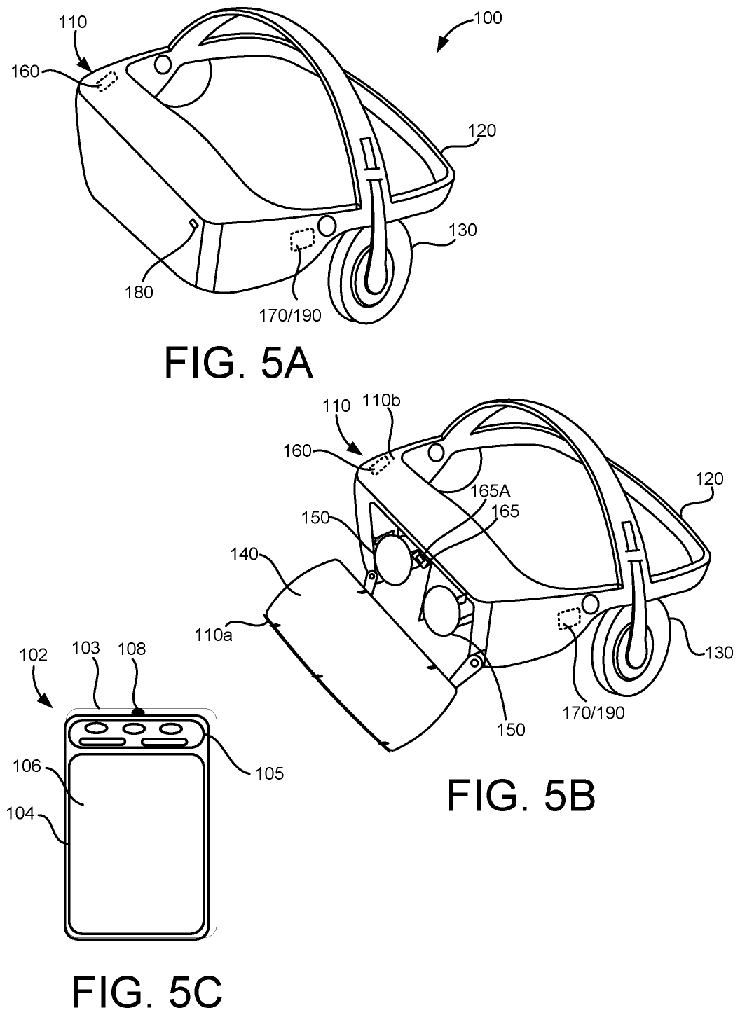

FIGS. 5A and 5B are perspective views of an example HMD, such as, for example, the HMD 100 worn by the user in FIG. 4, and FIG. 5C illustrates an example handheld electronic device, such as, for example, the handheld electronic device 102 shown in FIG. 1.

The handheld electronic device 102 may include a housing 103 in which internal components of the device 102 are received, and a user interface 104 on an outside of the housing 103, accessible to the user. The user interface 104 may include a touch sensitive surface 106 configured to receive user touch inputs. The user interface 104 may also include other components for manipulation by the user such as, for example, actuation buttons, knobs, joysticks and the like. In some implementations, at least a portion of the user interface 104 may be configured as a touchscreen, with that portion of the user interface 104 being configured to display user interface items to the user, and also to receive touch inputs from the user on the touch sensitive surface 106. The handheld electronic device 102 may also include a light source 108 configured to selectively emit light, through a port in the housing 103, and other manipulation devices 105 manipulatable by the user.

The HMD 100 may include a housing 110 coupled to a frame 120, with an audio output device 130 including, for example, speakers mounted in headphones, also be coupled to the frame 120. In FIG. 2B, a front portion 110a of the housing 110 is rotated away from a base portion 110b of the housing 110 so that some of the components received in the housing 110 are visible. A display 140 may be mounted on an interior facing side of the front portion 110a of the housing 110. Lenses 150 may be mounted in the housing 110, between the user's eyes and the display 140 when the front portion 110a is in the closed position against the base portion 110b of the housing 110. In some implementations, the HMD 100 may include a sensing system 160 including various sensors and a control system 170 including a processor 190 and various control system devices to facilitate operation of the HMD 100.

In some implementations, the HMD 100 may include a camera 180 to capture still and moving images. The images captured by the camera 180 may be used to help track a physical position of the user and/or the handheld electronic device 102 in the real world, and/or may be displayed to the user on the display 140 in a pass through mode, allowing the user to temporarily leave the virtual environment and return to the physical environment without removing the HMD 100 or otherwise changing the configuration of the HMD 100 to move the housing 110 out of the line of sight of the user.

In some implementations, the HMD 100 may include a gaze tracking device 165 to detect and track an eye gaze of the user. The gaze tracking device 165 may include, for example, an image sensor 165A, or multiple image sensors 165A, to capture images of the user's eyes, for example, a particular portion of the user's eyes, such as, for example, the pupil, to detect, and track direction and movement of, the user's gaze. In some implementations, the HMD 100 may be configured so that the detected gaze is processed as a user input to be translated into a corresponding interaction in the immersive virtual experience.

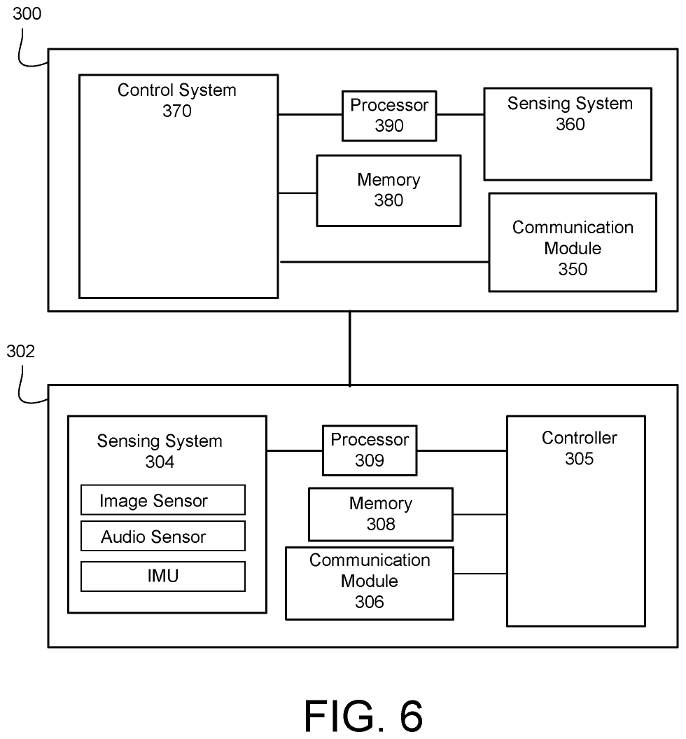

A block diagram of a system providing for teleportation and scaling in an augmented and/or virtual reality environment is shown in FIG. 6. The system may include a first electronic device 300 in communication with a second electronic device 302. The first electronic device 300 may be, for example an HMD as described above with respect to FIGS. 1, 5A and 5B, generating an immersive virtual environment, and the second electronic device 302 may be, for example, a handheld electronic device as described above with respect to FIGS. 1 and 5C, that is in communication with the first electronic device 300 to facilitate user interaction with the immersive virtual environment generated by the first electronic device 300.

The first electronic device 300 may include a sensing system 360 and a control system 370, which may be similar to the sensing system 160 and the control system 170, respectively, shown in FIGS. 5A and 5B. The sensing system 360 may include one or more different types of sensors, including, for example, a light sensor, an audio sensor, an image sensor, a distance/proximity sensor, and/or other sensors and/or different combination(s) of sensors, including, for example, an image sensor positioned to detect and track the user's eye gaze, such as the gaze tracking device 165 shown in FIG. 5B. The control system 370 may include, for example, a power/pause control device, audio and video control devices, an optical control device, a transition control device, and/or other such devices and/or different combination(s) of devices. The sensing system 360 and/or the control system 370 may include more, or fewer, devices, depending on a particular implementation. The elements included in the sensing system 360 and/or the control system 370 may have a different physical arrangement (e.g., different physical location) within, for example, an HMD other than the HMD 100 shown in FIGS. 5A and 5B. The first electronic device 300 may also include a processor 390 in communication with the sensing system 360 and the control system 370, a memory 380, and a communication module 350 providing for communication between the first electronic device 300 and another, external device, such as, for example, the second electronic device 302.

The second electronic device 302 may include a communication module 306 providing for communication between the second electronic device 302 and another, external device, such as, for example, the first electronic device 300. In addition to providing for the exchange of data between the first electronic device 300 and the second electronic device 302, the communication module 306 may also be configured to emit a ray or beam as described above to communicate an electronic signal. The second electronic device 302 may include a sensing system 304 including an image sensor and an audio sensor, such as is included in, for example, a camera and microphone, an inertial measurement unit including, for example an accelerometer and/or a gyroscope and/or a magnetometer, a touch sensor such as is included in a touch sensitive surface of a handheld electronic device, or smartphone, and other such sensors and/or different combination(s) of sensors. A processor 309 may be in communication with the sensing system 304 and a controller 305 of the second electronic device 302, the controller 305 having access to a memory 308 and controlling overall operation of the second electronic device 302.

As noted above, a controller, such as, for example, the handheld electronic device 102 described above, may be manipulated by a user for interaction and navigation in the virtual environment. When navigating in the virtual environment, the user may direct, or point, the handheld electronic device 102 to a virtual feature to be selected, and a virtual beam may be generated by the system, based on, for example, orientation information generated by the sensors of the handheld electronic device 102, to identify the virtual feature and/or location to be selected by the user. In some implementations, the light source 108 may direct a ray or beam toward a virtual feature or item to be selected, and the ray or beam generated by the light source 108 may be detected by the system (for example, by a camera on the HMD 100) and a rendering of the detected ray or beam may be displayed to the user in the virtual environment for selection of the virtual feature.

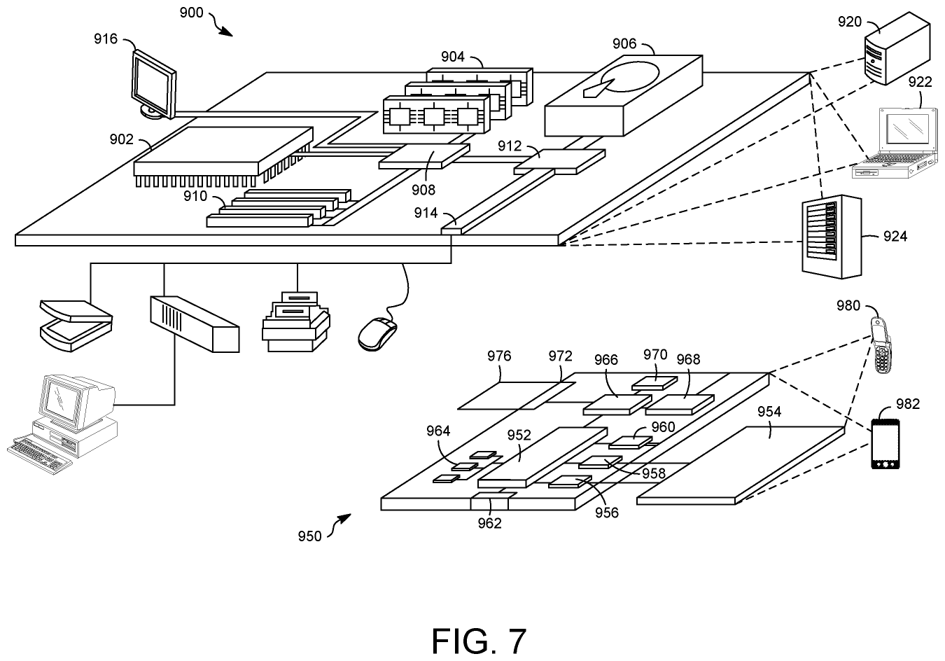

FIG. 7 shows an example of a generic computer device 900 and a generic mobile computer device 950, which may be used with the techniques described here. Computing device 900 is intended to represent various forms of digital computers, such as laptops, desktops, tablets, workstations, personal digital assistants, televisions, servers, blade servers, mainframes, and other appropriate computing devices. Computing device 950 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 900 includes a processor 902, memory 904, a storage device 906, a high-speed interface 908 connecting to memory 904 and high-speed expansion ports 910, and a low speed interface 912 connecting to low speed bus 914 and storage device 906. The processor 902 can be a semiconductor-based processor. The memory 904 can be a semiconductor-based memory. Each of the components 902, 904, 906, 908, 910, and 912, are interconnected using various busses, and may be mounted on a common motherboard or in other manners as appropriate. The processor 902 can process instructions for execution within the computing device 900, including instructions stored in the memory 904 or on the storage device 906 to display graphical information for a GUI on an external input/output device, such as display 916 coupled to high speed interface 908. In other implementations, multiple processors and/or multiple buses may be used, as appropriate, along with multiple memories and types of memory. Also, multiple computing devices 900 may be connected, with each device providing portions of the necessary operations (e.g., as a server bank, a group of blade servers, or a multi-processor system).

The memory 904 stores information within the computing device 900. In one implementation, the memory 904 is a volatile memory unit or units. In another implementation, the memory 904 is a non-volatile memory unit or units. The memory 904 may also be another form of computer-readable medium, such as a magnetic or optical disk.

The storage device 906 is capable of providing mass storage for the computing device 900. In one implementation, the storage device 906 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 904, the storage device 906, or memory on processor 902.

The high speed controller 908 manages bandwidth-intensive operations for the computing device 900, while the low speed controller 912 manages lower bandwidth-intensive operations. Such allocation of functions is exemplary only. In one implementation, the high-speed controller 908 is coupled to memory 904, display 916 (e.g., through a graphics processor or accelerator), and to high-speed expansion ports 910, which may accept various expansion cards (not shown). In the implementation, low-speed controller 912 is coupled to storage device 906 and low-speed expansion port 914. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 900 may be implemented in a number of different forms, as shown in the figure. For example, it may be implemented as a standard server 920, or multiple times in a group of such servers. It may also be implemented as part of a rack server system 924. In addition, it may be implemented in a personal computer such as a laptop computer 922. Alternatively, components from computing device 900 may be combined with other components in a mobile device (not shown), such as device 950. Each of such devices may contain one or more of computing device 900, 950, and an entire system may be made up of multiple computing devices 900, 950 communicating with each other.

Computing device 950 includes a processor 952, memory 964, an input/output device such as a display 954, a communication interface 966, and a transceiver 968, among other components. The device 950 may also be provided with a storage device, such as a microdrive or other device, to provide additional storage. Each of the components 950, 952, 964, 954, 966, and 968, are interconnected using various buses, and several of the components may be mounted on a common motherboard or in other manners as appropriate.

The processor 952 can execute instructions within the computing device 950, including instructions stored in the memory 964. The processor may be implemented as a chipset of chips that include separate and multiple analog and digital processors. The processor may provide, for example, for coordination of the other components of the device 950, such as control of user interfaces, applications run by device 950, and wireless communication by device 950.

Processor 952 may communicate with a user through control interface 958 and display interface 956 coupled to a display 954. The display 954 may be, for example, a TFT LCD (Thin-Film-Transistor Liquid Crystal Display) or an OLED (Organic Light Emitting Diode) display, or other appropriate display technology. The display interface 956 may comprise appropriate circuitry for driving the display 954 to present graphical and other information to a user. The control interface 958 may receive commands from a user and convert them for submission to the processor 952. In addition, an external interface 962 may be provide in communication with processor 952, so as to enable near area communication of device 950 with other devices. External interface 962 may provide, for example, for wired communication in some implementations, or for wireless communication in other implementations, and multiple interfaces may also be used.

The memory 964 stores information within the computing device 950. The memory 964 can be implemented as one or more of a computer-readable medium or media, a volatile memory unit or units, or a non-volatile memory unit or units. Expansion memory 974 may also be provided and connected to device 950 through expansion interface 972, which may include, for example, a SIMM (Single In Line Memory Module) card interface. Such expansion memory 974 may provide extra storage space for device 950, or may also store applications or other information for device 950. Specifically, expansion memory 974 may include instructions to carry out or supplement the processes described above, and may include secure information also. Thus, for example, expansion memory 974 may be provide as a security module for device 950, and may be programmed with instructions that permit secure use of device 950. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 964, expansion memory 974, or memory on processor 952, that may be received, for example, over transceiver 968 or external interface 962.

Device 950 may communicate wirelessly through communication interface 966, which may include digital signal processing circuitry where necessary. Communication interface 966 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 968. In addition, short-range communication may occur, such as using a Bluetooth, WiFi, or other such transceiver (not shown). In addition, GPS (Global Positioning System) receiver module 970 may provide additional navigation- and location-related wireless data to device 950, which may be used as appropriate by applications running on device 950.

Device 950 may also communicate audibly using audio codec 960, which may receive spoken information from a user and convert it to usable digital information. Audio codec 960 may likewise generate audible sound for a user, such as through a speaker, e.g., in a handset of device 950. Such sound may include sound from voice telephone calls, may include recorded sound (e.g., voice messages, music files, etc.) and may also include sound generated by applications operating on device 950.

The computing device 950 may be implemented in a number of different forms, as shown in the figure. For example, it may be implemented as a cellular telephone 980. It may also be implemented as part of a smart phone 982, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device (computer-readable medium), for processing by, or to control the operation of, data processing apparatus, e.g., a programmable processor, a computer, or multiple computers. Thus, a computer-readable storage medium can be configured to store instructions that when executed cause a processor (e.g., a processor at a host device, a processor at a client device) to perform a process.

A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be processed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the processing of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT), a light emitting diode (LED), or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What is claimed is:

1. A method, comprising:
generating, by a virtual reality application, a virtual environment;
determining that a button has been actuated;
causing a virtual change in the virtual environment and a physical change in a physical environment in response to the determining that the button has been actuated, the virtual change being a virtual representation of the physical change.

2. The method of claim 1, wherein the button comprises at least one of:
a physical button or switch that may be physically selected or actuated; or
a soft button or virtual button displayed on a display that may be selected.

3. The method of claim 2, wherein the soft button or virtual button comprises:
a graphical user interface (GUI) element that may be selected to start the virtual reality application and to cause a change to be performed in the physical environment that is the same as at least one characteristic of the virtual reality application.

4. The method of claim 1, wherein the causing a change comprises:
causing, at the same time, both a first change in the virtual environment and a second change in a physical environment in response to the determining that the button has been actuated, wherein the first change in the virtual environment is the same as the second change in the physical environment.

5. The method of claim 4, wherein at least one of the following is performed:
the first change in the virtual environment being the same as the second change in the physical environment; and
the second change in the physical environment is the same as the first change in the virtual environment.

6. The method of claim 4, wherein the causing a change comprises:
causing, at the same time, both a first change in the virtual environment and a second change in a physical environment in response to the determining that the button has been actuated, wherein a first characteristic of the first change in the virtual environment is the same as a second characteristic of the second change in the physical environment.

7. The method of claim 6, wherein the first characteristic and the second characteristic relate to at least one of temperature, lights, movement, position, sound, music, or scent.

8. A system, comprising:
a computing device configured to generate an immersive virtual environment, the computing device including:
a memory storing executable instructions; and
a processor configured to execute the instructions to cause the computing device to:
determine that a button has been actuated; and
cause a virtual change in the virtual environment and a physical change in a physical environment in response to the determining that the button has been actuated, the virtual change being a virtual representation of the physical change.

9. The system of claim 8, wherein the processor is configured to cause, at the same time, both a first change in the virtual environment and a second change in a physical environment in response to the determine, wherein the first change in the virtual environment is the same as the second change in the physical environment.

10. A method, comprising:
receiving an indication of a selected mode;
providing, in both a virtual environment and a physical environment, a change of an environmental condition based on the selected mode,
wherein a characteristic of the environmental condition of the virtual environment is the same as a characteristic of the environmental condition of the physical environment.

11. The method of claim 10, wherein the receiving comprises at least one of:
detecting a selection of a physical button or switch that may be physically selected or actuated; and
detecting a selection of a soft button or virtual button displayed on a display that may be selected.

12. The method of claim 10:
wherein the receiving comprises receiving, by a first device, the indication of the selected mode; and
wherein the providing, in both the virtual environment and the physical environment, the change of an environmental condition based on the selected mode includes:
performing a first change in a first environment, either the virtual environment or the physical environment, in response to the selected mode; and
sending, from the first device to a second device, a control signal to indicate the selected mode to cause the second device to perform a second change in a second environment, either the physical environment or the virtual environment, the second environment being a different environment than the first environment.

13. The method of claim 10, further comprising generating, by a virtual reality system, a virtual environment;
wherein the receiving includes receiving, by a virtual reality system, the indication of the selected mode; and
wherein the providing, in both the virtual environment and the physical environment, the change of an environmental condition based on the selected mode includes:
performing, by the virtual reality system, a first change in the virtual environment based on the selected mode; and
sending, from the virtual reality system to a controller configured to control one or more characteristics of the physical environment, a control signal to indicate the selected mode to cause the controller to perform a second change in the physical environment based on the selected mode.

14. The method of claim 13, wherein the performing a first change in the virtual environment comprises at least one of:
executing or running, by the virtual reality system, a virtual reality application based on the selected mode;
displaying, by the virtual reality system, information on a display to present or display a virtual environment to the user based on the selected mode.

15. The method of claim 13, wherein the sending a control signal to a controller comprises:
sending, by the virtual reality application, a control signal, indicating the selected mode, to a controller to cause the controller to perform a second change in the physical environment with respect to one or more characteristics of a user.

16. The method of claim 13, wherein the sending a control signal to a controller comprises:
sending, by the virtual reality application, a control signal, indicating the selected mode, to at least one of:
a controller configured to control one or more lights or lighting within a room;
a controller configured to control a fan, a heater or an air conditioner or to control a temperature within a room based on the selected mode;
a controller configured to move or adjust a location of a piece of furniture based on the selected mode;
a controller configured to cause motion with one or more physical items based on the selected mode;
a controller configured to control or output sounds, music or other audio information based on the selected mode; and
a controller configured to control a scent within a room based on the selected mode.

17. The method of claim 10, wherein the characteristic of environmental condition of the virtual environment and the physical environment includes a weather-related condition, the weather-related condition relates to at least one of temperature, air pressure, lighting, water, scent, or sound.

18. The method of claim 10, wherein the characteristic of environmental condition of the virtual environment and the physical environment includes a positional-related condition, the positional-related condition relates to at least one of a position level of a user or a position level of a furniture.

19. The method of claim 10, wherein the characteristic of environmental condition of the virtual environment and the physical environment includes a movement-related condition, the movement-related condition relates at least one of a movement of a user or a movement of a furniture.

20. A method, comprising:
receiving an indication of a selected mode in response to a physical button or switch that may be physically selected or actuated;
providing a first environmental condition in a virtual environment;
providing a second environmental condition in a physical environment; and
causing a change in both the first environmental condition of the virtual environment and the second environmental condition of the physical environment such that the first environmental condition of the virtual environment corresponds to the second environmental condition of the physical environment.
